(19) United States
(12) Patent Application Publication
(10) Pub. No.: US 2017/0183076 A1
(43) Pub. Date: Jun. 29, 2017

(54) DOOR SYSTEM FOR AN EXHAUST GAS DUCT OF AN AUXILIARY POWER UNIT OF AN AIRCRAFT

(71) Applicant: Airbus Operations, S.L., Getafe (ES)

(72) Inventors: Pío FERNÁNDEZ LÓPEZ, Getafe (ES); Pedro Felipe RAMOS-PAUL LASTRA, Getafe (ES); Cristina SADUÑO OBREGON, Getafe (ES); Víctor BARREIRO RODRÍGUEZ, Getafe (ES); David PULPON BEJAS, Getafe (ES)

(21) Appl. No.: 15/385,405

(22) Filed: Dec. 20, 2016

(30) Foreign Application Priority Data
Dec. 23, 2015 (EP) 15382660.7

(51) Int. Cl. B64C 1/14; B64D 41/00

(52) U.S. Cl. CPC B64C 1/14; B64D 41/00

(57) ABSTRACT

A door system configured to be attached to the fuselage of a tail cone of an aircraft wherein the tail cone comprises an exhaust gas duct of an auxiliary power unit of the aircraft and an opening of the exhaust gas duct located at the rear part of the tail cone. The door system comprises a door which is movable between an open and a closed position, the door being configured such that, in the closed position, it covers the opening of the exhaust gas duct and that the door being shaped such that it follows the aerodynamic shape of the fuselage of the tail cone in its closed position.

### CROSS-REFERENCES TO RELATED APPLICATIONS

This application claims the benefit of the European patent application No. 15382660.7 filed on Dec. 23, 2015, the entire disclosures of which are incorporated herein by way of reference.

### FIELD OF THE INVENTION

The present invention refers to a door system suitable for an exhaust gas duct of an auxiliary power unit compai linent of an aircraft.

### BACKGROUND OF THE INVENTION

Auxiliary power units (“APU”) are used in aircraft to provide electrical power and compressed air to various aircraft systems and components. When an aircraft is on the ground, its main source of electrical power and cabin conditioning comes from the APU. In particular, the APU can power the environmental control systems, air drive hydraulic pumps and the starters for the engines. When an aircraft is in flight, the APU may provide pneumatic and/or electric power to the aircraft.

Typically, APUs are located in the aft section of the aircraft, at or near the tailcone section and include inlet and exhaust ducting that exit through an opening, or cut-out, at the rear part of the aircraft fuselage to allow sufficient air flow through to the APU.

The combustion system, under control of the APU controller, receives a flow of fuel from a fuel source and the compressed air from the compressor, and supplies high-energy combusted gas to the power turbine, causing it to rotate. The gas is then exhausted from the APU via the exhaust duct.

Most of current aircraft fuselage rear parts have the outlet of the APU exhaust duct left open to the atmosphere, even when the APU is not running.

This open hole affects the rear fuselage aerodynamics, creating some additional drag.

### SUMMARY OF THE INVENTION

It is an object of the invention to provide a door system that is attached to the fuselage of the tail cone of the aircraft. As previously stated, the rear part of the tail cone comprises an exhaust gas duct of an auxiliary power unit.

The door system comprises a door which is movable between an open and a closed position, the door being configured such that, in the closed position, it covers the opening of the exhaust gas and additionally the door is shaped such that it follows the aerodynamic shape of the tail cone in its closed position or what is the same, in a cross-section carried out by a plane perpendicular to the Z-axis of the aircraft, the door continues the line of the fuselage in the cross-section.

Therefore, the invention comprises a door system for reducing the rear fuselage aerodynamic drag added by the open outlet of the APU exhaust that it is reduced by properly closing this open exhaust duct by incorporating a door movable between an open and a closed position depending if the APU is running or not.

It is also an additional object of the invention to provide a tail cone of an aircraft that comprises an exhaust gas duct of an auxiliary power unit as previously stated, and a door system according to the preceding technical features.

### BRIEF DESCRIPTION OF THE DRAWINGS

To complete the description and in order to provide for a better understanding of the invention, a set of drawings is provided. The drawings form an integral part of the description and illustrate preferred embodiments of the invention. The drawings comprise the following figures.

FIG. 1 shows a perspective view of the rear part of an aircraft having a door system according to one embodiment of the invention.

FIG. 2 shows a schematic plan view of an embodiment of the door system in a closed and in an open position.

FIG. 3 shows a schematic plan view of an embodiment of a door in a closed position.

FIG. 4 shows a schematic plan view of an embodiment of a door in an open position.

FIGS. 5A and 5B show a schematic plan view of an embodiment of both arms of the door of FIGS. 3 and 4, respectively.

FIGS. 6A, 6B and 6C show a schematic front view of an embodiment of an actuation system in a closed (6A) and in an open (6C) position with an enlarged view of the actuation gear (6B).

FIG. 7 shows a rear schematic view of the tail cone of an aircraft having an embodiment of the door system in an open position of the doors.

FIG. 8A shows a side schematic view of the embodiment shown in FIG. 7.

FIG. 8B shows a top schematic view of the embodiment shown in FIG. 7.

FIG. 9 and FIG. 10 show a rear schematic view of the tail cone of an aircraft having an embodiment of the door system in an open and closed position of the doors.

### DETAILED DESCRIPTION OF THE PREFERRED EMBODIMENTS

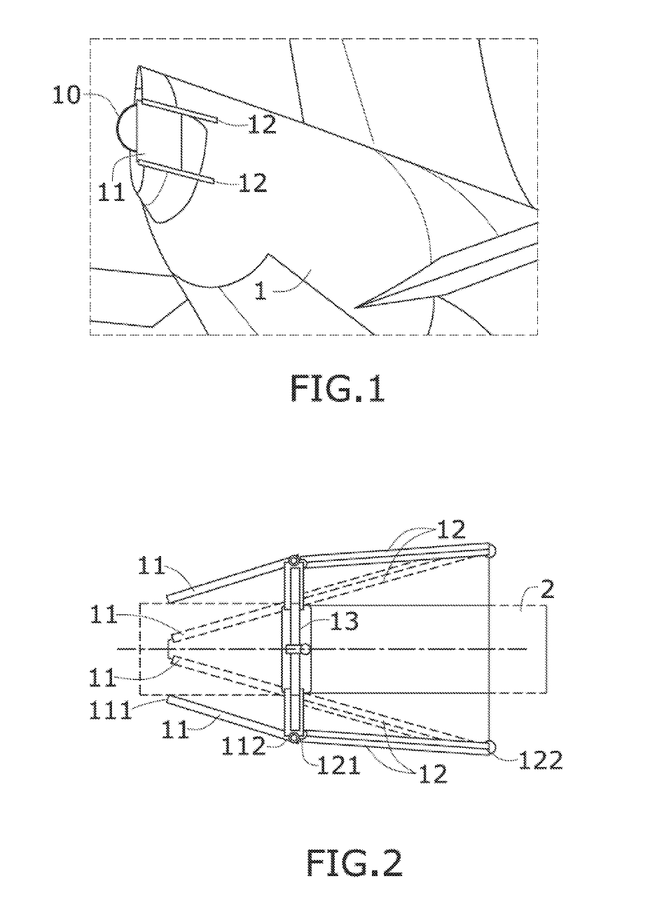

FIG. 1 discloses an embodiment of a door (11) attached to the fuselage (1) of the tail cone of an aircraft. It also discloses the opening (10) of the exhaust gas duct (2) of the auxiliary power unit of the aircraft.

As can be seen, the door (11) is shaped such that it follows the shape of the tail cone (1) in the closed position. Additionally, the door (11) is joined to the fuselage through two arms (12).

FIG. 2 shows a plan view of a schematic representation in a closed and in an open position (in dash lines) of an embodiment of the door system comprising two doors (11). The embodiment comprises two doors (11) that are configured to be located symmetrically with respect to the longitudinal axis of the aircraft, each door (11) comprises a rear end (111) and a forward end (112). In the closed position, both doors (11) follow the aerodynamic shape of the fuselage (1) of the aircraft such that they continue the line of the fuselage (1) of the aircraft.

FIG. 2 also discloses the actuation system (13) configured such that it actuates on the forward end (112) of the doors (11) such that it moves the forward end (112) in a direction perpendicular to the longitudinal axis of the aircraft, for moving the door (11) between the closed and the open position. The whole door (11) is displaced in a parallel movement. More specifically, the doors (11) are moved along the X-direction (lateral horizontal direction) of the aircraft. In the open position, the doors (11) are moved until the rear end (111) surpasses the projection of the opening (10) of the exhaust duct (2).

The disclosed system also comprises two arms (12) having a rear end (121) and a forward end (122), the rear end (121) of the arm (12) being pivotably joined to the forward (112) end of the door (11) and the forward end (122) being pivotably fixed or secured to the fuselage (1) of the aircraft.

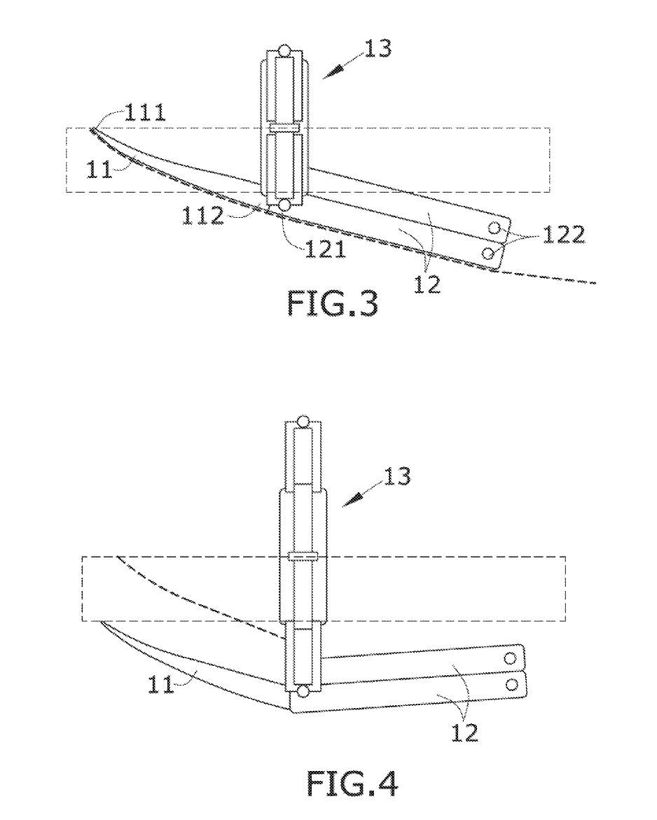

FIG. 3 also discloses the same embodiment of FIG. 2 showing one door (11), an arm (12) and the actuation system (13) in a closed position.

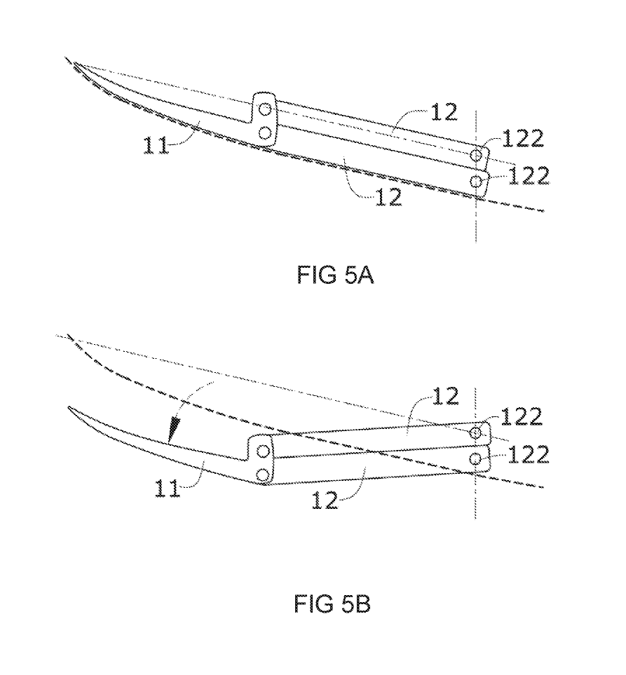

FIG. 4 discloses the embodiment of FIG. 3 in an open position and FIGS. 5A and 5B disclose that each door (11) is connected to two arms (12) that move as a parallelogram together with the door (11). It is preferred to have both arms (12) to provide robustness and stability to the door (11) when moving in and out while exposed to the aerodynamic forces.

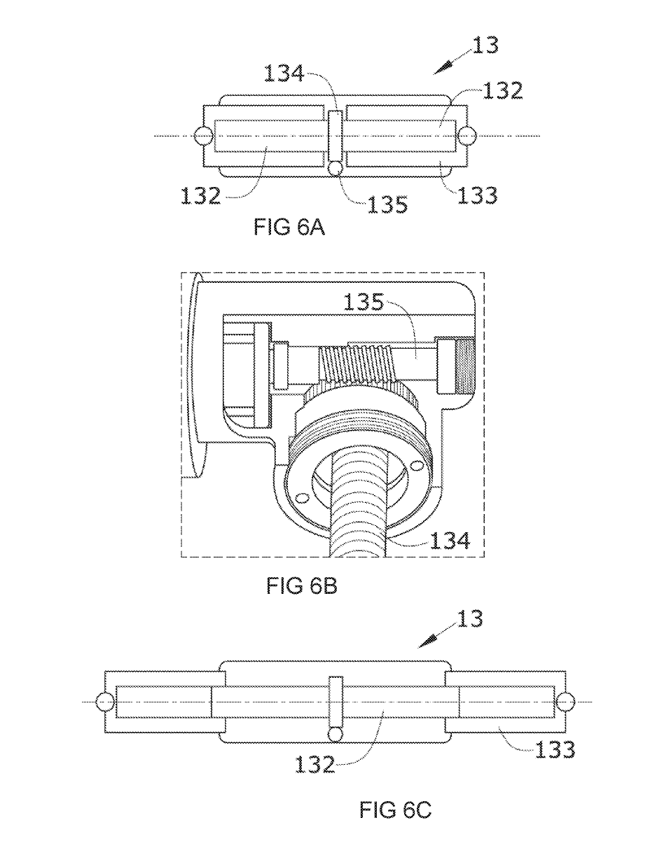

Regarding the actuation system (13), the embodiment shown in the figures, for instance in FIGS. 6A, 6B and 6C, comprises a screwed together male (132) and female (133) part configured such that the female part (133) is movable with respect to the male (132) part for opening and closing the doors (11). Particularly, the actuation system (13) comprises guided female turnbuckles and male turnbuckles that are actuated by a toothed gear (134) in connection with a rotating shaft (135) with an external screw thread.

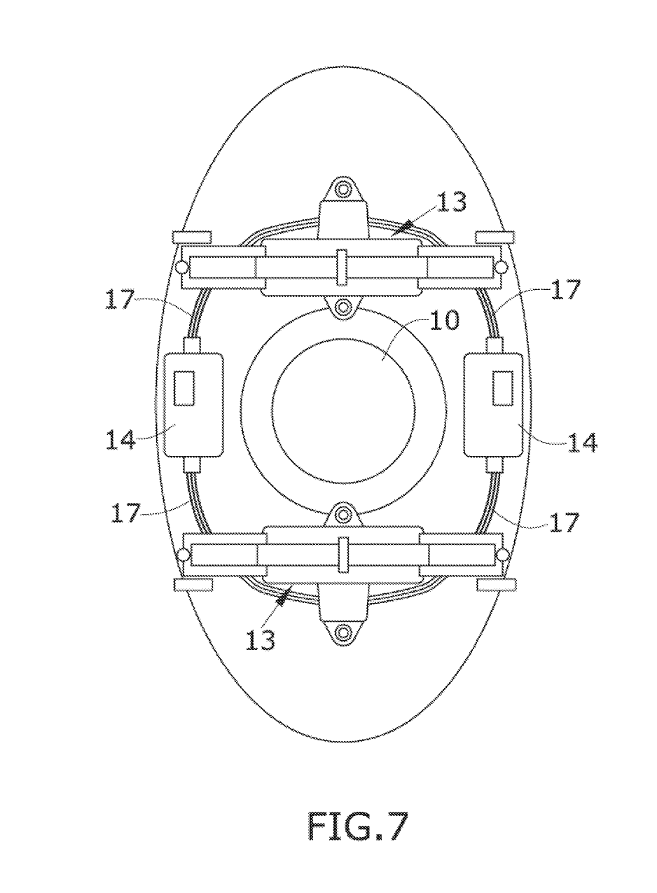

FIG. 7 discloses a particular embodiment of the invention showing a rear view of the rear part of the tail cone and the exhaust opening (10). The actuation system (13) comprises an upper and a lower actuation system (13), the upper actuation system (13) being connected with the upper arms of the doors (11) and the lower actuation system (13) being connected with the lower arms of the door (11).

FIG. 7 also discloses two rotating motors (14), each rotating motor (14) being linked to each door (11). Each rotating motor (14) is connected to a flexible cable (17) and therefore each rotating motor (14) transmits its shaft's rotation to the flexible cables (17) connected at both ends of the motor shaft.

The embodiment also comprises two actuators (16) which change the rotational movement of the flexible cables (17) into a different direction of rotation due to a bevel gear (161) at 90° located inside the actuator (16) box. The bevel gear (161) is linked to the rotating shaft (135).

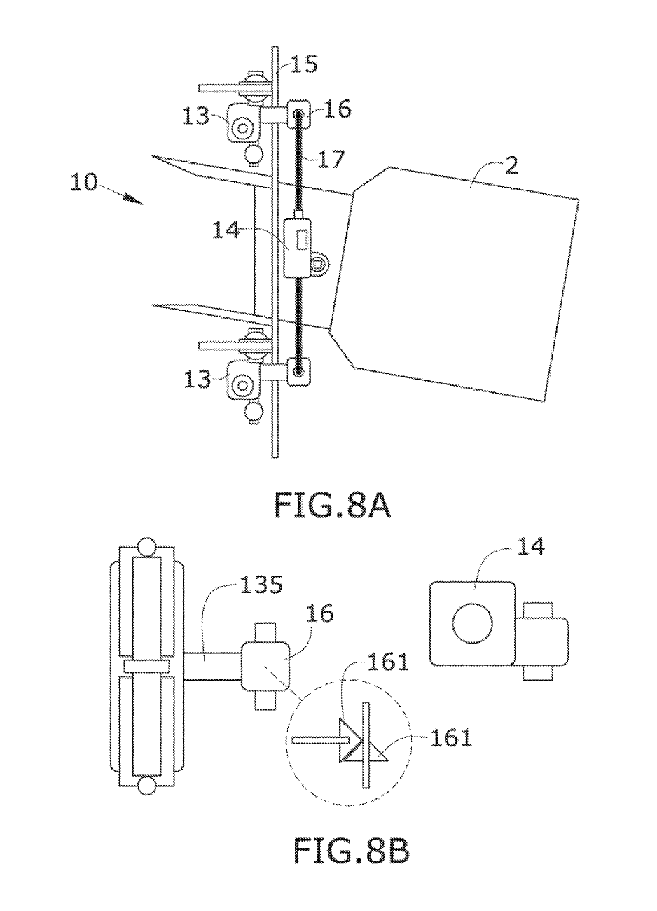

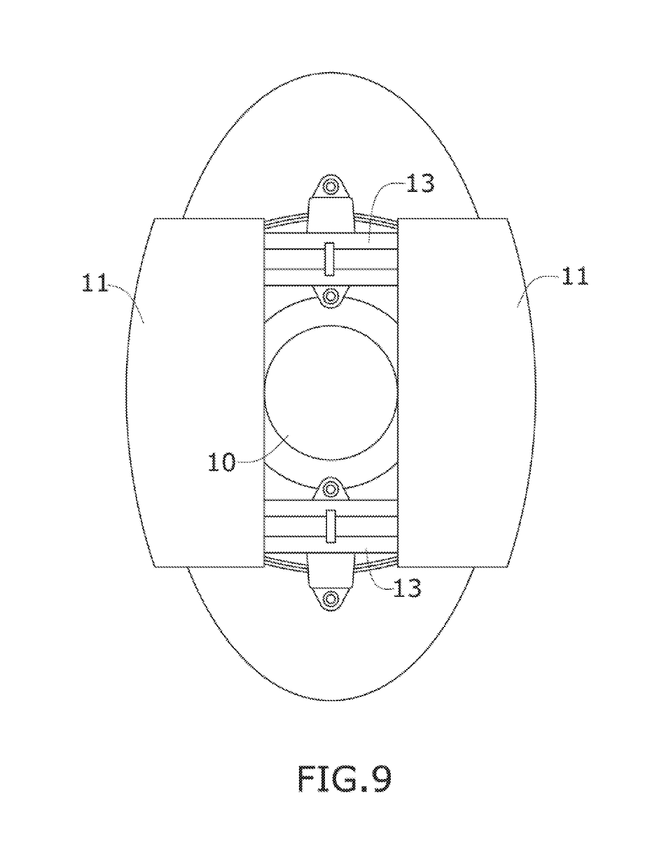

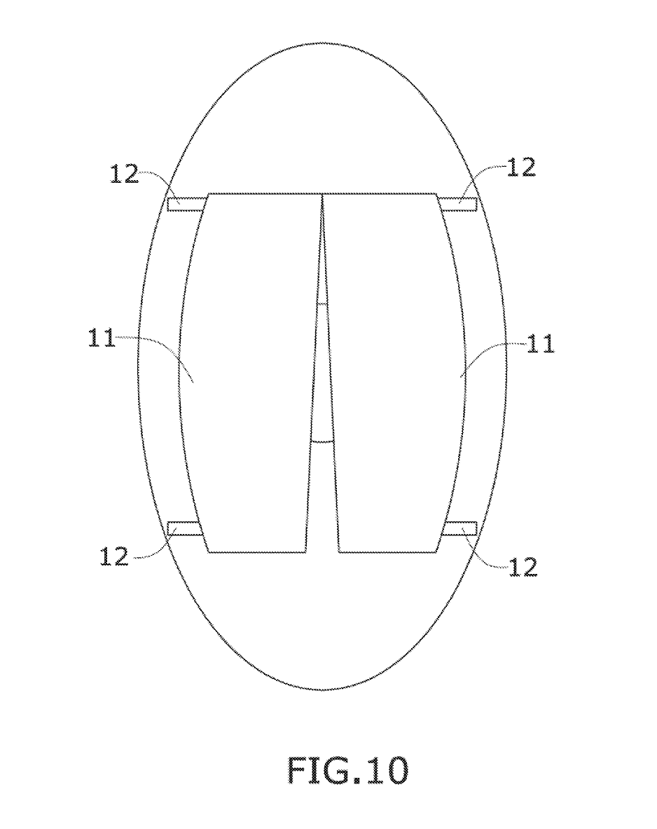

FIG. 8 discloses that the actuation system (13) is attached to a frame (15) of the fuselage of the aircraft and FIGS. 9 and 10 disclose an embodiment of the door system in an open and closed position.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A door system configured to be attached to the fuselage of a tail cone of an aircraft wherein the tail cone comprises an exhaust gas duct of an auxiliary power unit of the aircraft and an opening of the exhaust gas duct located at the rear part of the tail cone, the door system comprising:
a door movable between an open and a closed position,
the door being configured such that, in the closed position, the door covers the opening of the exhaust gas duct, and
the door being shaped such that the door follows the aerodynamic shape of the fuselage of the tail cone in the closed position.

2. The door system, according to claim 1, comprising two doors configured to be located symmetrically with respect to a vertical plane containing a longitudinal axis of the aircraft.

3. The door system, according to claim 2, comprising:
the two doors each having a rear end and a forward end,
an actuation system configured such that the actuation system actuates on the forward end of each door such that the actuation system moves the forward end in a lateral horizontal direction for moving the door between the closed and the open position.

4. The door system, according to claim 3, further comprising at least two arms each having a rear end and a forward end, the rear end of each of the arms being pivotably joined to the forward end of one of the two doors and the forward end of the arms being pivotably attached to the fuselage of the aircraft.

5. The door system, according to claim 3, wherein the actuation system comprises screwed together male and female parts, configured such that the female part is movable with respect to the male part in the lateral horizontal direction of the aircraft, for opening and closing the doors.

6. The door system, according to claim 5, wherein the actuation system comprises a toothed gear in connection with a rotating shaft with screw threads.

7. The door system, according to claim 4, wherein each door is linked to two arms.

8. A tail cone of an aircraft, comprising an exhaust gas duct of an auxiliary power unit, comprising the door system according to claim 1.

9. A tail cone of an aircraft, comprising an exhaust gas duct of an auxiliary power unit, comprising the door system according to claim 6.

10. The tail cone of an aircraft, according to claim 9, wherein the actuation system is attached to a frame of the fuselage of the aircraft.

11. The tail cone of an aircraft, according to claim 9, wherein the door system comprises:
a lower and an upper actuation system, each of the actuation systems being provided in connection with both doors,
two rotating motors, each rotating motor driving one of the doors and each rotating motor being connected with the lower and the upper actuation systems.

12. The tail cone of an aircraft, according to claim 11, wherein the door system comprises a flexible cable connected to each rotating motor such that the motor
transmits a rotation of a motor shaft to the flexible cables, the flexible cables being connected to the actuation systems.

13. The tail cone of an aircraft, according to claim 12, wherein the door system comprises two actuators, each comprising a bevel gear for changing the rotational movement of the flexible cable into a different direction of rotation, the actuator linked to the rotating shaft.
